(19) United States
(12) Patent Application Publication
(10) Pub. No.: US 2014/0090309 A1
(43) Pub. Date: Apr. 3, 2014

(54) CUBIC BORON NITRIDE PARTICLES HAVING A UNIQUE MORPHOLOGY

(71) Applicant: DIAMOND INNOVATIONS, INC., Worthington, OH (US)

(72) Inventor: Timothy F. Dumm, Westerville, OH (US)

(73) Assignee: DIAMOND INNOVATIONS, INC., Worthington, OH (US)

(21) Appl. No.: 14/028,965

(22) Filed: Sep. 17, 2013

Related U.S. Application Data
(60) Provisional application No. 61/709,250, filed on Oct. 3, 2012.

(51) Int. Cl. C09K 3/14

(52) U.S. Cl. CPC C09K 3/1409
USPC 51/309; 51/307

(57) ABSTRACT

A superabrasive particle, such as cubic boron nitride, and method of making the same are disclosed. A cubic boron nitride particle may have an irregular surface, wherein the surface roughness of said particle is less than about 0.95. The method for producing abrasive particles having a unique surface morphology may comprise the steps of providing a plurality of abrasive particles; blending reactive metal powder with the abrasive particles; compressing the blended components into a pellet; heating said pellet; and recovering modified abrasive particles.

### CROSS-REFERENCE TO RELATED APPLICATIONS

This application claims priority of provisional application No. 61/709,250, filed Oct. 3, 2012, titled “Cubic Boron Nitride Particles Having a Unique Morphology”.

### TECHNICAL FIELD AND INDUSTRIAL APPLICABILITY

The present invention relates to hard particles used for abrasive grinding, honing, finishing, polishing and other applications. More specifically, this invention relates to cubic boron nitride particles that have a unique morphology. The cubic boron nitride (CBN) particles of this invention have a roughened surface texture for enhancing performance in industrial applications.

### BACKGROUND OF THE INVENTION

Abrasive particles are used in many applications such as grinding, honing, finishing, polishing and other surface finishing applications. Common abrasive particles include aluminum oxide, silicon carbide, boron carbide and tungsten carbide. These particles can be referred to as conventional abrasives and have a Moh's hardness of less than 9.0 Diamond and cubic boron nitride are referred to as superabrasive particles and have a Moh's hardness of 9.5-10. When superabrasive particles like diamond or cubic boron nitride are used in grinding and finishing applications, the tools last much longer than conventional abrasives and because of the low wear rates, workpiece tolerances are maintained for longer periods of time before the tools need to be replaced. Cubic boron nitride abrasives are particularly advantageous when grinding or finishing ferrous materials. This is because, although diamond is harder than cubic boron nitride, diamond reacts detrimentally with iron and nickel at high temperatures causing a significant reduction in performance. Cubic boron nitride, however, does not react with iron or nickel and abrasive performance is maintained even at high temperatures created in the grinding process.

Although superabrasive tools perform better than those using conventional abrasives, optimal performance depends on how well the tools retain the abrasive particles and on how well the particles interact with the workpiece material. An important part of a tool's performance depends on how well the abrasive particles are bonded to the tool. Many types of bonds may be used for making superabrasive tools. These include metal, vitreous (glass) and resin type bonds. The bonding, or holding, of the abrasive in a tool may be achieved through physical and/or chemical attachment with the bonding material. The degree of physical attachment may be affected by the roughness of the abrasive particle. Particles having smooth surfaces and no chemical bonding must rely on being heavily enveloped in the bonding material in order to be adequately retained in the tool. In this case, as the surrounding bond material wears away and the abrasive particle becomes more exposed, the bond will eventually fail to hold the abrasive and it will pull out of the tool. The pull-out phenomenon often occurs well before the useful life of the abrasive is obtained. This effect limits the tool from realizing its full value in an application. Similar particles having a rougher morphology will be retained in the tool longer and will extend the useful life of the tool. This will reduce processing costs and improve quality for the parts that are processed. An additional benefit of using a surface-roughened CBN crystal would be that the exposed roughness will improve the free-cutting ability of the tool thereby allowing the tool to achieve the same amount of work with less energy. Also, the micro-features established by the roughness on the abrasive could result in a surface roughness on the workpiece that is lower than what would have been achieved with a standard abrasive.

Mesh-size CBN particles tend to have smooth, faceted faces and even the finer, micron size CBN particles display smooth surfaces. As such, pull-outs are a common phenomenon when using CBN abrasives in metal bond and resin-bond tools. A common method of improving the retention of CBN in abrasive tools is by applying a metallic coating to the abrasive. The coating surface itself may then either provide a rougher surface for better mechanical retention, or the coating may allow better chemical attachment to the bond material. An example of a coating that provides roughness is an electroless nickel coating. Nickel coatings of this type are usually applied to the abrasive particles such that the nickel comprises 50-70% by weight of the coated abrasive. Although the nickel coating is rougher and provides improved mechanical retention, the nickel itself is not chemically bonded to the abrasive and is only a shell around the particle. Therefore, it is still possible for the abrasive to pop-out of the bonded nickel at a point before the full use of the abrasive has been realized. Nickel coated abrasives are commonly used in resin-bonded tools.

Another example of a coating used for improving retention is a titanium coating. Unlike the electroless nickel coating, titanium coatings are applied to the abrasives using chemical vapor deposition methods. In this case, the titanium is chemically bonded to the particle. However, even the coating is chemically bonded to the particle; the thin titanium coatings do not impart any additional roughness to the abrasive surface. Titanium coatings improve chemical bonding when the abrasive is used in a metallic bond. If this chemical bond is not sufficient, pullouts can still occur.

To date, the methods employed for increasing the roughness of CBN particles has been limited to metal coatings and etching the surface with caustic or alkaline chemicals. A new approach has been developed that utilizes certain metals that react strongly with CBN to form deep pits and spikes on the surface of the particles. These features are different than those formed by caustic chemical etching and provide a new type of CBN abrasive that can add performance improvement over existing CBN.

As can be seen, there is a need for a superabrasive and method of making superabrasive for roughened surface texture for enhancing performance in industrial applications.

### SUMMARY OF THE INVENTION

In one aspect of the present invention, a cubic boron nitride particle having an irregular surface, wherein the surface roughness of said particle is less than about 0.95.

In another aspect of the present invention, a method for producing abrasive particles may have a unique surface morphology comprising the steps of providing a plurality of abrasive particles; blending reactive metal powder with the abrasive particles; compressing the blended components into a pellet; heating said pellet; and recovering modified abrasive particles.

In further another aspect of the present invention, a plurality of cubic boron nitride particles may have irregular surfaces, wherein the average surface roughness of said particles is less than about 0.95.

In yet another aspect of the present invention, a plurality of abrasive particles may have irregular surfaces, wherein the average sphericity of said particles is at less than about 0.70.

The foregoing and other objects, features and advantages of the invention will become understood from the following disclosure in which one or more embodiments of the invention are described in drawings, descriptions and claims. It is contemplated that variations in procedures may appear to a person skilled in the art without departing from the scope of or sacrificing any of the advantages of the invention.

### BRIEF DESCRIPTION OF THE DRAWINGS

FIG. 1 shows results of x-ray diffraction analysis of CBN powder that was heated with aluminum powder for 1 hour at 1400° C. according to an exemplary embodiment. The analysis shows aluminum nitride peaks indicative of a solid state reaction has occurred.

FIG. 2a shows scanning electron microscope (SEM) images of conventional 8-15 μm CBN according to another exemplary embodiment;

FIG. 2b shows scanning electron microscope (SEM) images of 8-15 μm CBN modified using an aluminum powder process according to another exemplary embodiment.

FIG. 3a shows scanning electron microscope (SEM) images of conventional 2-4 μm CBN according to another exemplary embodiment;

FIG. 3b shows scanning electron microscope (SEM) images of 2-4 μm CBN modified using an aluminum powder process according to another exemplary embodiment; and

FIG. 4 shows a method of making modified cubic boron nitride particles according an exemplary embodiment.

### DETAILED DESCRIPTION OF EXEMPLARY EMBODIMENTS

Before the present methods, systems and materials are described, it is to be understood that this disclosure is not limited to the particular methodologies, systems and materials described, as these may vary. It is also to be understood that the terminology used in the description is for the purpose of describing the particular versions or embodiments only, and is not intended to limit the scope. For example, as used herein and in the appended claims, the singular forms “a,” “an,” and “the” include plural references unless the context clearly dictates otherwise. In addition, the word “comprising” as used herein is intended to mean “including but not limited to.” Unless defined otherwise, all technical and scientific terms used herein have the same meanings as commonly understood by one of ordinary skill in the art.

Unless otherwise indicated, all numbers expressing quantities of ingredients, properties such as size, weight, reaction conditions and so forth used in the specification and claims are to the understood as being modified in all instances by the term “about”. Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

As used herein, the term “about” means plus or minus 10% of the numerical value of the number with which it is being used. Therefore, about 50% means in the range of 45%-55%.

### DEFINITIONS

In describing and claiming the present invention, the following terminology will be used in accordance with the definitions set forth below.

The term “abrasive”, as used herein, refers to any material used to wear away softer material.

The term “material removal”, as used herein, refers to the weight of a workpiece removed in a given period of time reported in milligrams, grams, etc.

The term, “material removal rate”, as used herein, refers to material removed divided by the time interval reported as milligrams per minute, grams per hour, etc.

The term “particle”, as used herein, refers to a discrete body. A particle is also considered a crystal or a grain.

The term “pit”, as used herein, refers to an indentation or crevice in the surface of a particle, either an indentation or crevice in the surface of a two-dimensional image or an indentation or crevice in an object.

The term “spike”, as used herein, refers to a sharp projection pointing outward from the centroid of a particle, a sharp projection pointing outward from the centroid of a two-dimensional image or a sharp projection pointing outward from an object.

The term “superabrasive”, as used herein, refers to an abrasive possessing superior hardness and abrasion resistance. CBN and cubic boron nitride are examples of superabrasives and have Knoop indentation hardness values of over 7500.

The term “weight loss”, as used herein, refers to the difference in weight of a group of particles before being subject to the modification treatment of the present invention and the weight of the same mass of CBN particles or abrasive particles after being subject to the modification treatment of the present invention.

The term “workpiece”, as used herein, refers to parts or objects from which material is removed by grinding, polishing, lapping or other material removal methods.

The term “perimeter”, as used herein, refers to the boundary of a closed plane figure or the sum of all borders of a two-dimensional image.

The term “convex perimeter”, as used herein, refers to a line joining Feret tangent points, where Feret is the distance between two parallel tangents touching the boundary on each side of a two dimensional image or object.

The term “surface roughness”, as used herein, refers to the measurement of a two-dimensional image that quantifies the extent or degree of pits and spikes of an object's edges or boundaries as stated in the CLEMEX image analyzer, Clemex Vision User's Guide PE 3.5©2001. Surface roughness is determined by the ratio of the convex perimeter divided by the perimeter.

$$Surface Roughness = \frac{ConvexPerimeter}{Perimeter}$$

Note that as the degree of pits and spikes increases, the surface roughness factor decreases.

The term “sphericity”, as used herein, refers to the estimate of the enclosed area of a two dimensional image or object (4πA) divided by the square of perimeter (p²).

$$Sphericity = \frac{4 π A}{{p}^{2}}$$

The term “surface area” as used herein, refers to the external surface of a particle. When used with a plurality of particles, i.e., powder, the term specific surface area is used and is reported as surface area per gram of powder.

It is important to note that although the terms defined above refer to measuring two-dimensional particle profiles using microscopic measuring techniques, it is understood that the features extend to the three-dimensional form. Automated image analysis of particle size and shape is recognized by one skilled in the art as a reliable, reproducible method of measuring particle characteristics. Although the CLEMEX image analyzer was used, similar devices are available that will reproduce the data.

The present invention relates to abrasive particles having a unique surface morphology. Further, the invention includes a process for modifying cubic boron nitride (cBN) particles for obtaining rough, irregular particles having a unique surface morphology. The process for modifying the surface of the CBN requires that aluminum is used as a reactant metal with the CBN. At high temperatures, it has been found that the CBN will react with aluminum and form aluminum nitride. This reaction is thought to create pits and spikes in the surface of the CBN. After the reaction occurs, the aluminum nitride can be removed revealing the roughened CBN surface. The CBN particles of the present invention include a significantly roughened surface texture whereby many intricate pockets or etch-pits are established on the surface of the CBN. This texture provides many more sharp cutting edges on a particle than are present on typical CBN particle. It is expected that tool performance improves in applications utilizing the CBN particles of the present invention. These applications include precision grinding where the CBN particles are incorporated within a resin, metal or vitrified bond system. It is also expected that the CBN particles of the present invention improve the performance in honing and superfinishing especially where the bonding materials include resins, metals or glass fits. The CBN particles of the present invention would be expected to improve the performance of tools in instances where the particles are electroplated or electroformed to the tool or when the CBN particles are co-deposited within a coating.

The modification process of the present invention may also be used in modifying other forms of CBN including, but not limited to, monocrystalline and polycrystalline CBN. The present invention applies to a wide range of CBN sizes from hundreds of microns in diameter to micron sized powders.

In one exemplary embodiment of the present invention, CBN particles in sizes of less than about 100 microns are used. However, CBN particles in sizes over about 100 microns may be used as well. In an exemplary embodiment, the sizes of the CBN particles range from about 0.1 to about 500 microns. An example of CBN particles that may be used is BMP-I 8-15 micron, cubic boron nitride particles manufactured by Diamond Innovations (Worthington, Ohio, U.S.A).

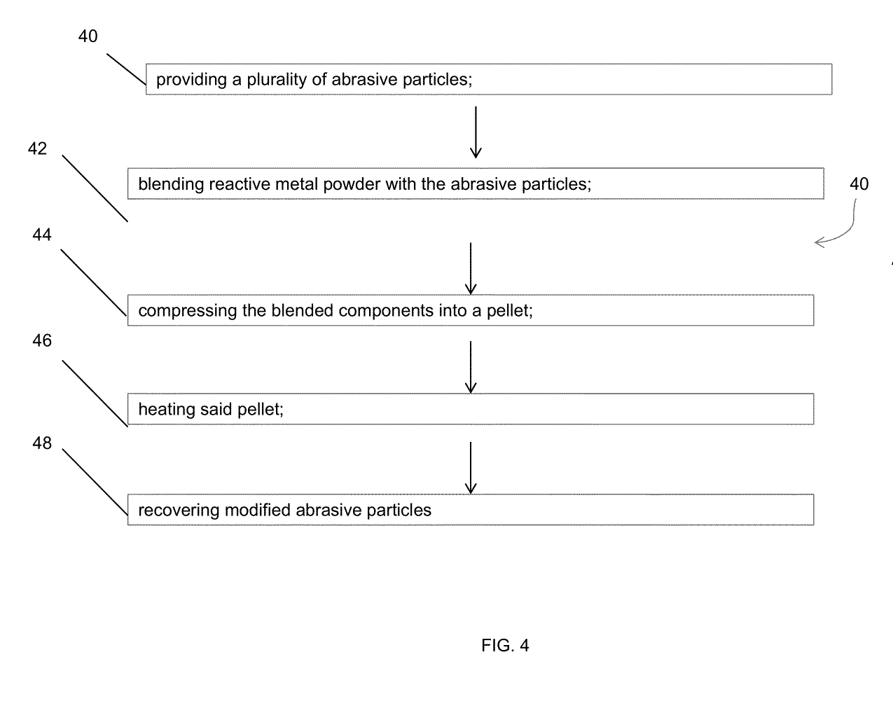

As shown in FIG. 4, in an exemplary embodiment, a method 40 for producing abrasive particles having a unique surface morphology may comprise: providing a plurality of abrasive particles, such as cubic boron nitride particles in a step 40; blending reactive metal powder with the abrasive particles in a step 42; compressing the blended components into a pellet in a step 44; heating said pellet in a step 46; and recovering modified abrasive particles in a step 48. The cubic boron nitride particles may be monocrystalline cBN particles. The reactive metal powder may be aluminum, for example. The heating metal coated particles may be at least about 1200° C. The ratio of metal powder to the abrasive particles may be 1:10 to 10:1, for example. The abrasive particles modified via the method 40 may have an average weight loss of more than about 5% of the weight loss compared to conventional abrasive particles not subjected to the method.

To create the CBN particles of the present invention, from about 10 to about 80 weight percent CBN particles and from about 20 to about 90 weight percent aluminum particles are mixed using any appropriate mixing method that achieves a uniform mixture. In the present invention, the weighed portions of the aluminum and CBN particles may be put into a jar, sealed and inserted into a mixing device such as a Turbula® shaker-mixer (Glen Mills, Inc., Clifton, N.J., U.S.A) for at least about one hour or, alternatively, about 30 minutes to about one hour. A binder may optionally be added to the mixture prior to mixing. Binders provide lubricity to particle surfaces allowing a denser packing and more intimate contact between the metal powder and CBN. Binders also help in holding a pressed body together as a green-body.

The mixture is then compressed so as to create an intimate mixture of CBN particles and aluminum particles. Any method may be used to compress the CBN particles and aluminum particles so long that they form an intimate mixture and the particles are in very close contact with one another. One method used to compress the mixture may be to place the mixture into a fixed die set on a press. An example of a suitable press is a Carver® pellet press manufactured by Carver, Inc. (Wabash, Ind.). In the die press, the mixture is subjected to pressure between about 5 and about 50,000 psi, between about 10,000 to about 40,000 psi or between about 15,000 to about 30,000 psi to form a pellet. Although pelletizing the mixture is taught, it is not necessary that the mixture of CBN and aluminum particles be formed into a pellet, only that the particles be compressed so as to form intimate contact with one another. Isostatic pressing with deformable tooling may also be used to achieve the intimate contact.

Alternatively, the mixture may also be compressed by pressing it into a thin sheet that is several millimeters to several inches thick, i.e., by high pressure compaction rolls or briquetting rolls. The formed sheets may then be cut into smaller sections for further processing as discussed below. Another method of compressing the mixture of aluminum and CBN particles includes mixing and extruding the mixture under pressure. Pelletizing the mixture of CBN and aluminum particles via a pelletizer or tumbling the mixture in a tumbling apparatus are also alternative methods that may be used to compress the mixture. The pellets, bricks, briquetttes or cakes may be formed by these methods may then be further processed as discussed below.

Additional methods of compressing the mixture of aluminum and CBN particles include injection molding, extrusion, pressing the mixture into a container or tape casting. Alternatively, individual CBN particles may be coated with metal particles by ion implantation, sputtering, spray drying, electrolytic coating, electroless coating or any other applicable method so long as the aluminum and CBN particles are in intimate contact with each other.

After compressing the mixture of CBN and aluminum particles, the compressed mixture, which may be in a pellet, an aggregate or other condensed forms, is placed into a furnace and, in a hydrogen atmosphere, vacuum atmosphere, or an inert gas atmosphere, heated from about 900° C. to about 1600° C. Temperatures of about 1000° C. to about 1400° C. or about 1100° C. to about 1200° C., for example, may be used. The compressed mixture may be heated for a period of time from about five minutes up to about five hours, for example. Time periods ranging from about thirty minutes up to about two hours or of about one to about two hours, for example, may be used.

After the heating cycle is complete and the powder is cooled, the modified CBN particles are recovered by dissolving the aluminum/CBN pellets in common acids. Acids that are used may include hydrochloric acid, hydrofluoric acids, nitric acid and certain combinations thereof. Acids, or combinations thereof, are added in an acid-to-coated-CBN ratio of 100:1 up to 1000:1 (by volume). The mixture is then heated between about 100° C. to about 120° C. for a period of from about six to about eight hours, for example. The solution is then cooled, the liberated CBN settles and the solution is decanted. The acid cleaning and heating steps are repeated until substantially all of the aluminum has been digested.

Depending on the furnace conditions chosen, more or less reaction may occur between the metal and the CBN. The more the metal powder etches into the CBN, the more aluminum nitride is formed and, thus, more weight is lost by the CBN. To completely dissolve the aluminum nitride, higher quantities of acid may be used or additional dissolution treatments may be necessary. The CBN particles are then washed to remove acids and residue, such as in water. Subsequently, the CBN particles are dried in an oven, air dried, subjected to microwave drying or other drying methods known in the art.

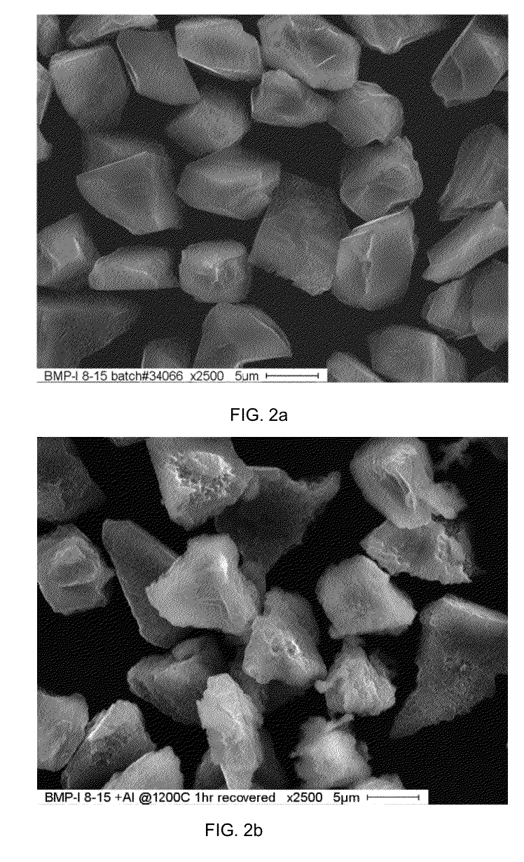

An embodiment of the present invention pertains to CBN particles having very rough, irregular surfaces as shown in FIG. 2(b). In addition to the roughened appearance, the CBN particles of the present invention have unique characteristics as compared to conventional CBN particles shown in FIG. 2(a). The conventional CBN particles produced by milling were not subjected to the modification treatment of the present invention.

An exemplary embodiment of cBN may comprise spikes and pits. The spikes act as cutting edges some applications. When the modified cBN particles are used in a fixed bond system, the pits and/or the spikes help secure the particle within the bond system.

The lengths of the spikes and depths of the pits may vary according to the modification treatment parameters. The average depth of the pits on a particle ranges in size from about 5% to about 70% of the longest length of the particles. In some exemplary embodiment, the depth of the pits on a particle may range in size from about 40% to about 60% of the longest length of the particle.

The modified cBN particles exhibit unique characteristics in surface roughness, sphericity and material removal. In one exemplary embodiment, the surfaces roughness of the modified cBN may be less than about 0.95, for example. In another exemplary embodiment, surface roughness of cBN may be between about 0.50 and about 0.80, for example

There may be a correlation between cBN weight loss and surface area. The specific surface area of the modified cBN particles having weight loss greater than 35% is about 20 percent higher compared to conventional cubic boron nitride particles having the same particle size distribution. It can be observed that the specific surface area of the particles is directly proportional to the extent of the reaction of the cubic boron nitride particles and iron particles during the modification treatment process.

The abrasive particles of the present invention may be useful in many applications including, lapping, grinding, cutting, polishing, dicing, sintered abrasives or abrasive compacts, wire for wire saws or honing. In general, one would expect that the roughened surface would aid in the retention of the CBN particle within the tool or resin bond system. The use of the abrasive of the present invention would aid in providing better retention of the abrasive particle in the metal or resin matrix, hence increasing the life of the wire saw. The abrasive of the present invention may also provide higher material removal rate with better free-cutting ability.

An exemplary embodiment of a plurality of cubic boron nitride particles having irregular surfaces, wherein the average surface roughness of said particles is less than about 0.95, may be used and incorporated into a tool, such as a grinding wheel, a fixed abrasive wire, a honing tool, a dicing blade, a polishing film, a chemical mechanical polishing (CMP) pad conditioner, a polishing compound, a composite cubic boron nitride wear coating, for example.

With regard to wire saw applications, the abrasive particles may be attached to a wire by electroplating, metal sintering or polymeric or resin bonds. Electroplated wire saws generally contain a single layer of abrasive particles co-deposited with a layer of nickel metal. Some wires also use a resin to attach the abrasive particles in the metal or resin matrix, hence increasing the life of the wire saw. The modified abrasive particles may also provide higher material removal rate with better free-cutting ability.

Materials typically cut with wire saws include silicon, sapphire, SiC, metals, ceramics, carbon, quartz, stone, glass, composite, and granite.

In another embodiments of the present invention, the surface modified abrasives and superabrasives may optionally be coated with a metal coating, i.e., a metal selected from Groups IVA, VA, VIA or an alloy thereof, including combinations thereof.

### Example I

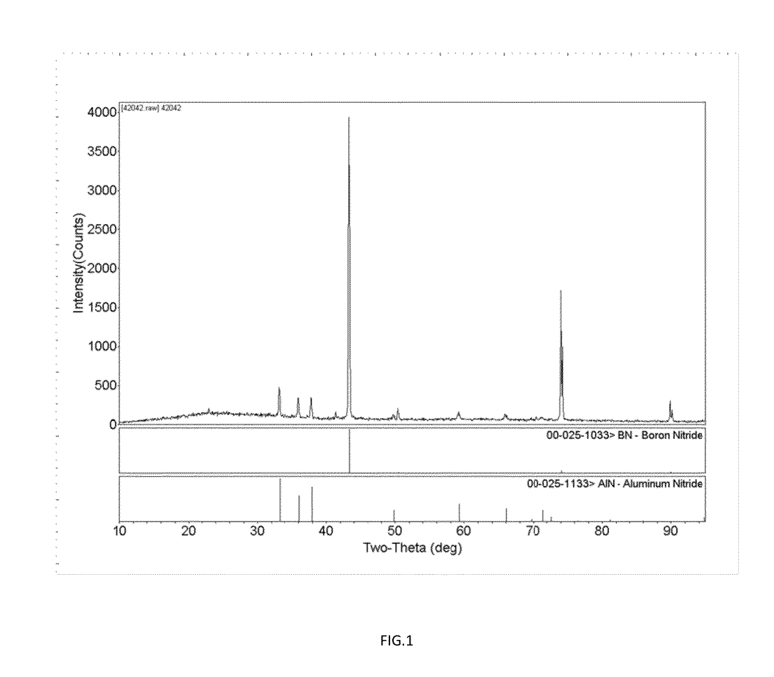

A 8-15 μm monocrystalline CBN powder with a mean size of 12 μm was blended with an aluminum powder with a mean size of 3 μm using a blend ratio of 40 weight percent CBN particles and 60 weight percent aluminum powder (no binder). The blend was compacted into a 2 cm×0.5 cm pellet using a Carver® press at a pressure of 20,000 psi. The pellet was heated at 1200° C. for 1 hour in forming gas atmosphere. The CBN pellet was allowed to cool. The CBN particles were recovered from the pellet by digesting in an acid mixture of 4:3:1, H₂O:HCl:HNO₃ until the pellet dissolved and the liberated particles settled to the bottom of the beaker. The CBN particles were neutralized with deionized water, recovered and dried. X-Ray diffraction analysis was performed on the powder and is shown in FIG. 1. These results show that some residual aluminum nitride is present in the powder confirming that a chemical reaction did occur. Samples of the recovered CBN were placed into a scanning electron microscope and photos were taken of these particles. FIG. 2(b) shows these particles and clearly shows evidence of significant surface etching. The unmodified 8-15 μm CBN particles are shown in the same FIG. 2(a) for comparison.

### Example II

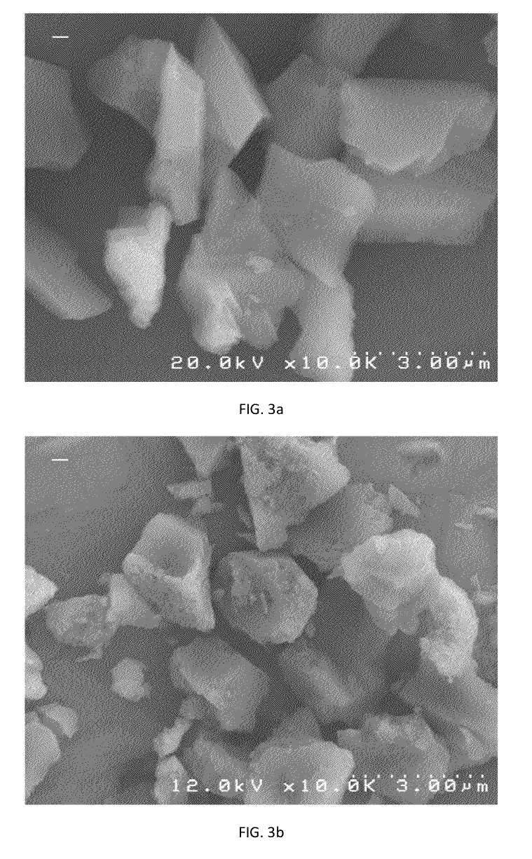

A 2-4 μm monocrystalline CBN powder with a mean size of 3 μm was blended with an aluminum powder with a mean size of 3 μm using a blend ratio of 40 weight percent CBN particles and 60 weight percent aluminum powder (no binder). The blend was compacted into a 2 cm×0.5 cm pellet using a Carver press at a pressure of 20,000 psi. The pellet was heated at 1200° C. for 1 hour in forming gas atmosphere. The CBN pellet was allowed to cool. The CBN particles were recovered from the pellet by digesting in an acid mixture of 4:3:1, H₂O:HCl:HNO3 until the pellet dissolved and the liberated particles were settled to the bottom of the beaker. The CBN particles were neutralized with deionized water, recovered and dried. Samples of the recovered CBN were placed into a scanning electron microscope and photos were taken for these particles. FIG. 3(b) shows these particles and clearly shows evidence of significant surface etching. The unmodified 2-4 μm CBN particles are shown in the same FIG. 3(a), for comparison.

### EQUIVALENTS

Although the invention has been described in connection with certain exemplary embodiments, it will be evident to those of ordinary skill in the art that many alternatives, modifications, and variations may be made to the disclosed invention in a manner consistent with the detailed description provided above. Also, it will be apparent to those of ordinary skill in the art that certain aspects of the various disclosed example embodiments could be used in combination with aspects of any of the other disclosed embodiments or their alternatives to produce additional, but not herein explicitly described, embodiments incorporating the claimed invention but more closely adapted for an intended use or performance requirements. Accordingly, it is intended that all such alternatives, modifications and variations that fall within the spirit of the invention are encompassed within the scope of the appended claims.

1. A cubic boron nitride particle having an irregular surface, wherein the surface roughness of said particle is less than about 0.95.

2. The particle of claim 1, wherein the surface roughness of said particle is between about 0.50 and about 0.80.

3. The particle of claim 1, wherein the sphericity of said particle is less than about 0.70.

4. The particle of claim 1, wherein the surface area of said particle is greater than about 20 percent higher than a conventional cubic boron nitride particle having the same particle size distribution.

5. The particle of claim 1, where the size of the particle is between about 0.1 to about 500 microns.

6. The particle of claim 1, wherein said particle comprises one or more spikes.

7. The particle of claim 1, wherein said particle comprises one or more pits.

8. The particle of claim 7, wherein the depth of the pits ranges in size from about 5% to about 70% of the longest length of the particle.

9. The particle of claim 8, wherein the depth of the pits ranges in size from about 40% to about 60% of the longest length of the particle.

10. The particle of claim 1, wherein said particle comprises a metallic coating.

11. A cubic boron nitride particle having a sphericity of less than about 0.70.

12. The particle of claim 11, wherein the sphericity of said particle is about 0.2 to about 0.5

13. The particle of claim 11, wherein the sphericity of said particle is about 0.25 to 0.4.

14. A method for producing abrasive particles having a unique surface morphology comprising the steps of:
providing a plurality of abrasive particles;
blending reactive metal powder with the abrasive particles;
compressing the blended components into a pellet;
heating said pellet; and
recovering modified abrasive particles.

15. The method of claim 14, wherein said abrasive particles are cubic boron nitride particles.

16. The method of claim 15, wherein said cubic boron nitride particles are monocrystalline CBN particles.

17. The method of claim 14, wherein said reactive metal powder is aluminum.

18. The method of claim 14, wherein said heating step comprises heating said metal coated particles to a temperature of at least about 1200° C.

19. The method of claim 14, wherein the ratio of metal powder to abrasive particles is 1:10 to 10:1.

20. The method of claim 14, wherein said modified abrasive particles have an average weight loss of more than about 5% of the weight loss compared to conventional abrasive particles not subjected to said method.
